(19) United States
(12) Patent Application Publication
(10) Pub. No.: US 2024/0202563 A1
(43) Pub. Date: Jun. 20, 2024

(54) QUANTUM COMPUTING SYSTEM, QUANTUM COMPUTING DEVICE, PROCESSING METHOD, AND STORAGE MEDIUM FOR STORING PROCESSING PROGRAM

(71) Applicant: DENSO CORPORATION, Kariya-city (JP)

(72) Inventor: TADASHI KADOWAKI, Kariya-city (JP)

(21) Appl. No.: 18/537,597

(22) Filed: Dec. 12, 2023

(30) Foreign Application Priority Data
Dec. 14, 2022 (JP) 2022-199676

(51) Int. Cl. G06N 10/40

(52) U.S. Cl. CPC G06N 10/40

(57) ABSTRACT

An optimization process for sequentially determining an optimal value of a contribution of an orthogonal magnetic field function based on a final state in an annealing process, for each of binary variable qubits that constitute an optimal solution of a combinatorial optimization problem, includes, when designating, as an optimal qubit, a qubit providing an optimal evaluation index in an evaluation of a final state of the annealing process in which a strength parameter of a pre-optimization qubit is varied for having a maximum value of the orthogonal magnetic field function, (i) extracting of the optimal qubit based on the evaluation index; (ii) determining of the strength parameter; and (iii) outputting of the optimal solution by mapping a set of the strength parameters determined for all qubits.

### CROSS REFERENCE TO RELATED APPLICATION

This application is based on an incorporates herein by reference Japanese Patent Application No. 2022-199676 filed on Dec. 14, 2022.

### TECHNICAL FIELD

The present disclosure relates to a processing technology for solving a combinatorial optimization problem with binary variables.

### BACKGROUND

There has been known quantum annealing that processes qubits corresponding to binary variables, as a processing technique for solving a combinatorial optimization problem, for example.

### SUMMARY

A first aspect of the present disclosure is a processing system controlling quantum annealing and a quantum gate for processing a binary variable qubit to solve a combinatorial optimization problem of binary variables, in which a processor is provided, and the processor is configured to execute:
an annealing process for individually time-controlling a contribution of each of:
(a) a cost function optimized in the combinatorial optimization problem;
(b) a transverse magnetic field function defining a magnetic field component orthogonal to the cost function; and
(c) an orthogonal magnetic field function defining a magnetic field component orthogonal to the cost function and the transverse magnetic field function, and
an optimization process for sequentially determining, for each of the binary variable qubits that constitute an optimal solution of the combinatorial optimization problem, an optimal value of the contribution of the orthogonal magnetic field function based on a final state in the annealing process, and
an optimal qubit is defined as a qubit providing an optimal evaluation index in an evaluation of a final state of the annealing process in which a strength parameter of a pre-optimization qubit is varied for having a maximum value of the orthogonal magnetic field function, the optimization process includes:
(i) extracting of the optimal qubit based on the evaluation index, which is phase information of a controlled qubit whose final states before and after the variation of the strength parameter are phase kicked-back states by a quantum gate circuit;
(ii) determining of the strength parameter, which is the optimal value of the extracted optimal qubit, according to the evaluation index; and
(iii) outputting of the optimal solution by mapping a set of the strength parameters determined for all qubits.

### BRIEF DESCRIPTION OF THE DRAWINGS

Objects, features, and advantages of the present disclosure will become more apparent from the following detailed description made with reference to the accompanying drawings, in which:

FIG. 1 is a block diagram illustrating an overall configuration of a quantum computing system according to one embodiment;

FIG. 2 is a block diagram illustrating a functional configuration of the quantum computing system according to the one embodiment;

FIG. 3 is a time transition diagram for explaining an annealing process according to the one embodiment;

FIG. 4 is a graph for explaining the annealing process according to the one embodiment;

FIG. 5 is a block diagram illustrating a quantum gate circuit according to the one embodiment;

FIG. 6 is a diagram of a table for explaining an optimization process according to the one embodiment;

FIG. 7 is another diagram of a table for explaining the optimization process according to the one embodiment;

FIG. 8 is yet another diagram of a table for explaining the optimization process according to the one embodiment;

FIG. 9 is still yet another diagram of a table for explaining the optimization process according to the one embodiment; and

FIG. 10 is a sequence diagram illustrating a processing method according to the one embodiment.

### DETAILED DESCRIPTION

Next, a relevant technology will be described below only for understanding the following embodiments. When quantum annealing that has a simple time-variation of the transverse magnetic field only is applied, there may be a difficulty in order to output the optimal solution having high-accuracy within the short processing time, expected for the quantum computing system.

It is one objective of the present disclosure to provide a quantum computing system that achieves both reduction in processing time and high-accuracy output of optimal solutions.

Another objective of the present disclosure is to provide a quantum computing device that achieves both reduction in processing time and high-accuracy output of optimal solutions.

Yet another objective of the present disclosure is to provide a processing method that achieves both reduction in processing time and high-accuracy output of optimal solutions.

Still yet another objective of the present disclosure is to provide a processing program that achieves both reduction in processing time and high-accuracy output of optimal solutions.

A first aspect of the present disclosure is a processing system controlling quantum annealing and a quantum gate for processing a binary variable qubit to solve a combinatorial optimization problem of binary variables, in which a processor is provided, and the processor is configured to execute:
an annealing process for individually time-controlling a contribution of each of:
(a) a cost function optimized in the combinatorial optimization problem;
(b) a transverse magnetic field function defining a magnetic field component orthogonal to the cost function; and
(c) an orthogonal magnetic field function defining a magnetic field component orthogonal to the cost function and the transverse magnetic field function, and
an optimization process for sequentially determining, for each of the binary variable qubits that constitute an optimal solution of the combinatorial optimization problem, an optimal value of the contribution of the orthogonal magnetic field function based on a final state in the annealing process, and
an optimal qubit is defined as a qubit providing an optimal evaluation index in an evaluation of a final state of the annealing process in which a strength parameter of a pre-optimization qubit is varied for having a maximum value of the orthogonal magnetic field function, the optimization process includes:
(iv) extracting of the optimal qubit based on the evaluation index, which is phase information of a controlled qubit whose final states before and after the variation of the strength parameter are phase kicked-back states by a quantum gate circuit;
(v) determining of the strength parameter, which is the optimal value of the extracted optimal qubit, according to the evaluation index; and
(vi) outputting of the optimal solution by mapping a set of the strength parameters determined for all qubits.

A second aspect of the present disclosure is a quantum computing device controlling quantum annealing and a quantum gate for processing a binary variable qubit to solve a combinatorial optimization problem of binary variables, the quantum computing device comprising:
a processor, wherein
(A) an annealing process is defined as a process for individually time-controlling a contribution of each of:
   (a) a cost function optimized in the combinatorial optimization problem;
   (b) a transverse magnetic field function defining a magnetic field component orthogonal to the cost function; and
   (c) an orthogonal magnetic field function defining a magnetic field component orthogonal to the cost function and the transverse magnetic field function; and
(B) an optimization process is defined as a process for sequentially determining, for each of the binary variable qubits that constitute an optimal solution of the combinatorial optimization problem, an optimal value of the contribution of the orthogonal magnetic field function based on a final state in the annealing process, and
(C) an optimal qubit is defined as a qubit for providing an optimal evaluation index in an evaluation of a final state of the annealing process in which a strength parameter of a pre-optimization qubit is varied for having a maximum value of the orthogonal magnetic field function,
the processor is configured to perform the optimization process including:
(i) extracting of the optimal qubit based on the evaluation index, which is phase information of a controlled qubit whose final states before and after the variation of the strength parameter are phase kicked-back states by a quantum gate circuit;
(ii) determining of the strength parameter, which is the optimal value of the extracted optimal qubit, according to the evaluation index; and
(iii) outputting of the optimal solution by mapping a set of the strength parameters determined for all qubits.

A third aspect of the present disclosure is a processing method performed by a processor, for controlling quantum annealing and a quantum gate for processing a binary variable qubit and for solving a combinatorial optimization problem of binary variables, which includes;
an annealing process for individually time-controlling a contribution of each of:
(a) a cost function optimized in the combinatorial optimization problem;
(b) a transverse magnetic field function defining a magnetic field component orthogonal to the cost function; and
(c) an orthogonal magnetic field function defining a magnetic field component orthogonal to the cost function and the transverse magnetic field function; and
an optimization process for sequentially determining, for each of the binary variable qubits that constitute an optimal solution of the combinatorial optimization problem, an optimal value of the contribution of the orthogonal magnetic field function based on a final state in the annealing process, and
an optimal qubit is defined as a qubit providing an optimal evaluation index in an evaluation of a final state of the annealing process in which a strength parameter of a pre-optimization qubit is varied for having a maximum value of the orthogonal magnetic field function, the optimization process includes:
(i) extracting of the optimal qubit based on the evaluation index, which is phase information of a controlled qubit whose final states before and after the variation of the strength parameter are phase kicked-back states by a quantum gate circuit;
(ii) determining of the strength parameter, which is the optimal value of the extracted optimal qubit, according to the evaluation index; and
(iii) outputting of the optimal solution by mapping a set of the strength parameters determined for all qubits.

A fourth aspect of the present disclosure is a processing method performed by a processor, for controlling quantum annealing and a quantum gate for processing a binary variable qubit and for solving a combinatorial optimization problem of binary variables, which includes;
a process is defined as an annealing process for individually time-controlling a contribution of each of:
(a) a cost function optimized in the combinatorial optimization problem;
(b) a transverse magnetic field function defining a magnetic field component orthogonal to the cost function; and
(c) an orthogonal magnetic field function defining a magnetic field component orthogonal to the cost function and the transverse magnetic field function; and
a process is defined as an optimization process for sequentially determining, for each of the binary variable qubits that constitute an optimal solution of the combinatorial optimization problem, an optimal value of the contribution of the orthogonal magnetic field function based on a final state in the annealing process, and
an optimal qubit is defined as a qubit providing an optimal evaluation index in an evaluation of a final state of the annealing process in which a strength parameter of a pre-optimization qubit is varied for having a maximum value of the orthogonal magnetic field function, the optimization process includes:
(i) extracting of the optimal qubit based on the evaluation index, which is phase information of a controlled qubit whose final states before and after the variation of the strength parameter are phase kicked-back states by a quantum gate circuit;
(ii) determining of the strength parameter, which is the optimal value of the extracted optimal qubit, according to the evaluation index; and
(iii) outputting of the optimal solution by mapping a set of the strength parameters determined for all qubits.

A fifth aspect of the present disclosure is a non-transitory, computer readable, tangible storage medium storing a processing program including instructions stored in a storage medium and executed by a processor, for controlling quantum annealing and a quantum gate for processing a binary variable qubit and for solving a combinatorial optimization problem of binary variables, which includes;
an annealing process performed according to the instructions for individually time-controlling a contribution of each of:
(a) a cost function optimized in the combinatorial optimization problem;
(b) a transverse magnetic field function defining a magnetic field component orthogonal to the cost function; and
(c) an orthogonal magnetic field function defining a magnetic field component orthogonal to the cost function and the transverse magnetic field function; and
an optimization process performed according to the instructions for sequentially determining, for each of the binary variable qubits that constitute an optimal solution of the combinatorial optimization problem, an optimal value of the contribution of the orthogonal magnetic field function based on a final state in the annealing process, and
an optimal qubit is defined as a qubit providing an optimal evaluation index in an evaluation of a final state of the annealing process in which a strength parameter of a pre-optimization qubit is varied for having a maximum value of the orthogonal magnetic field function, the optimization process includes:
(i) extracting of the optimal qubit based on the evaluation index, which is phase information of a controlled qubit whose final states before and after the variation of the strength parameter are phase kicked-back states by a quantum gate circuit;
(ii) determining of the strength parameter, which is the optimal value of the extracted optimal qubit, according to the evaluation index; and
(iii) outputting of the optimal solution by mapping a set of the strength parameters determined for all qubits.

A sixth aspect of the present disclosure is a non-transitory, computer readable, storage medium for storing a processing program including instructions stored in a storage medium and executed by a processor, for controlling quantum annealing and a quantum gate for processing a binary variable qubit and for solving a combinatorial optimization problem of binary variables, which includes;
a process designated as an annealing process for individually time-controlling a contribution of each of:
(a) a cost function optimized in the combinatorial optimization problem;
(b) a transverse magnetic field function defining a magnetic field component orthogonal to the cost function; and
(c) an orthogonal magnetic field function defining a magnetic field component orthogonal to the cost function and the transverse magnetic field function; and
a process designated as an optimization process for sequentially determining, for each of the binary variable qubits that constitute an optimal solution of the combinatorial optimization problem, an optimal value of the contribution of the orthogonal magnetic field function based on a final state in the annealing process, and
an optimal qubit is defined as a qubit providing an optimal evaluation index in an evaluation of a final state of the annealing process in which a strength parameter of a pre-optimization qubit is varied for having a maximum value of the orthogonal magnetic field function, the optimization process includes:
(i) extracting of the optimal qubit based on the evaluation index, which is phase information of a controlled qubit whose final states before and after the variation of the strength parameter are phase kicked-back states by a quantum gate circuit;
(ii) determining of the strength parameter, which is the optimal value of the extracted optimal qubit, according to the evaluation index; and
(iii) outputting of the optimal solution by mapping a set of the strength parameters determined for all qubits.

In the optimization process of the first to sixth aspects, the optimal value of the contribution of the orthogonal magnetic field function is sequentially determined for each of the qubits respectively corresponding to the binary variables based on the final state in the annealing process in which the contributions of the cost function, the transverse magnetic field function and the orthogonal magnetic field function are individually time-controlled. Then, a qubit with an optimal evaluation index for evaluating a final state in the annealing process, in which a strength parameter of a pre-optimization qubit is varied to have a maximum value of the orthogonal magnetic field function, is extracted as an optimal qubit. At this time, the extraction of the optimal qubit is performed based on the evaluation index, which is the phase information of the controlled qubit whose final states before and after the variation of the strength parameter have been phase kicked-back states by the quantum gate circuit.

According to the above, even when an annealing time in the annealing process is shortened, by sequentially determining the strength parameters that are the optimal values of the extracted optimal qubits according to the evaluation index, a solution space of the combinatorial optimization problem can be narrowed down. Accordingly, highly-accurate optimal solution can be output by mapping the set of the strength parameters determined for all qubits. Therefore, both of the reduction of the annealing time and the output of the optimal solution with high-accuracy are achievable without compromise.

Hereinafter, one embodiment of the present disclosure is described with reference to the drawings.

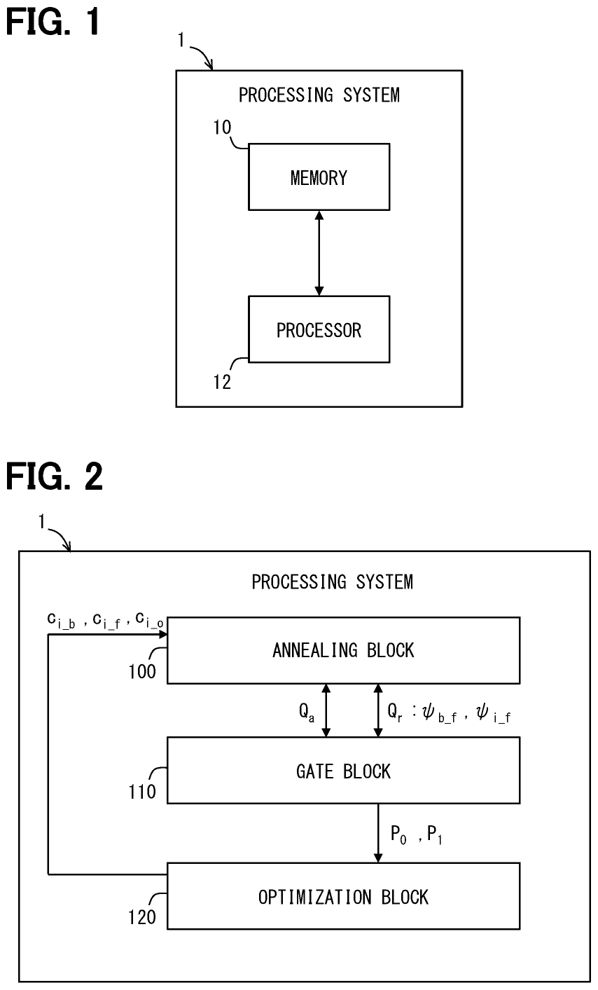

A quantum computing system 1 of the one embodiment shown in FIG. 1 is a quantum computing system configured to solve a combinatorial optimization problem with binary variables by controlling a quantum annealing with binary qubits. The quantum computing system 1 includes, as a plurality of dedicated computers, an annealing quantum computer that executes quantum bit-based operations by a quantum annealing method, and a gate quantum computer that executes quantum bit-based operations by a quantum gate method. The quantum computing system 1 may also include a classical computer that performs operations with classical bits as a dedicated computer in a combination of the annealing quantum computer and the gate quantum computer. At least one of the annealing quantum computer and the gate quantum computer, which are main components of the quantum computing system 1, may be, for example, a NISQ (Noisy Intermediate Scale Quantum) device or the like.

A dedicated computer that constitutes the quantum computing system 1 has a plurality of memories 10 and a plurality of processors 12. The plurality of memories 10 are at least one type of non-transitory, tangible storage medium, such as a semiconductor memory, a magnetic medium, and an optical medium, for non-transitory storage of computer readable programs and data. The plurality of processors 12 include at least (i) a quantum processing unit capable of realizing the quantum annealing method and (ii) a quantum processing unit capable of realizing the quantum gate method. The processors 12 of the classical computer that is combined with the quantum computer as the dedicated computer constituting the quantum computing system 1 may include at least one type of, for example, a CPU (Central Processing Unit), a GPU (Graphics Processing Unit), an RISC (Reduced Instruction Set Computer) CPU, and so on.

In the quantum computing system 1, the processors 12 control each of (i) the quantum annealing and (ii) the quantum gate that respectively process binary variable qubits, and executes the instructions included in the processing programs stored in a plurality of memories 10 to solve the combinatorial optimization problem of the binary variables. Thereby, the processors 12 constructs a plurality of functional blocks for controlling the quantum annealing and the quantum gate respectively to solve the combinatorial optimization problem. The functional blocks built in the quantum computing system 1 include an annealing block 100, a gate block 110 and an optimization block 120 as shown in FIG. 2.

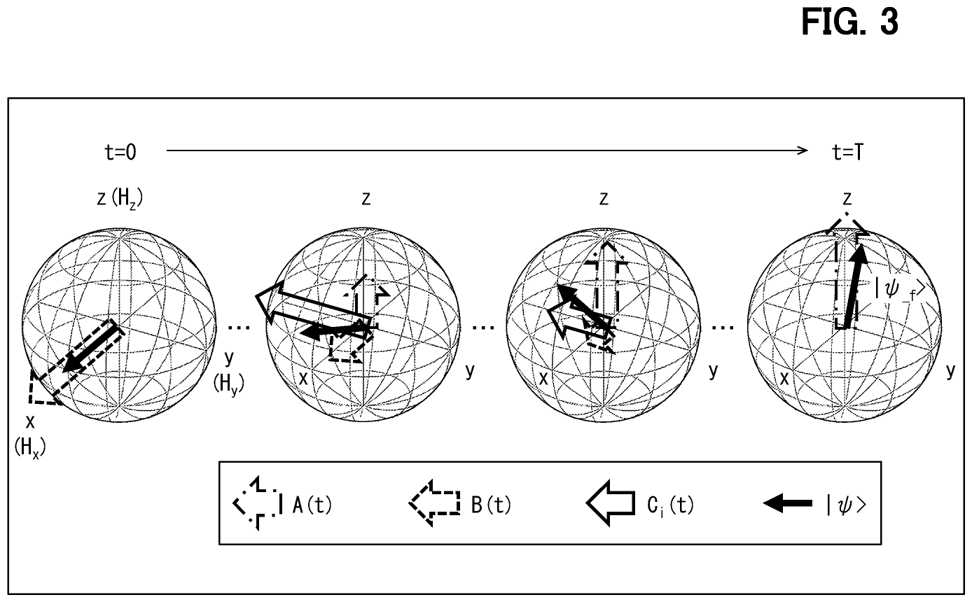

The annealing block 100 is implemented by the processors 12 in an annealing quantum computer or jointly with the processors 12 and the memory 10 set in a classical computer. The annealing block 100 performs an annealing process by the quantum annealing method. Specifically, the annealing block 100 of the present embodiment is configured to perform the annealing process such that contribution of each of a cost function H_{z}, a transverse magnetic field function Hₓ, and an orthogonal magnetic field function H_{y} shown in FIG. 3 is individually controlled in a time-dependent manner. Hereinafter, the annealing process by the annealing block 100 is referred to as a Qa (quantum annealing) process.

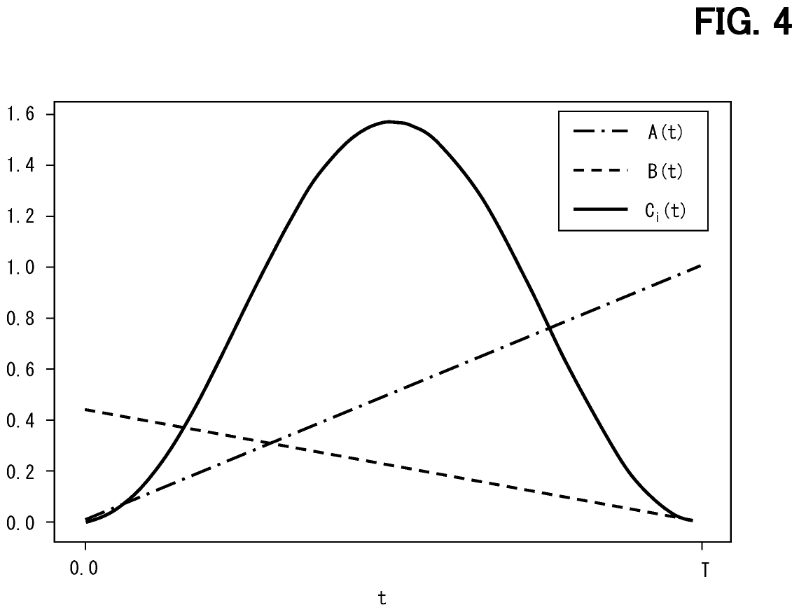

The QA process is based on an Ising model (i.e. spin glass model) in which binary variables of the combinatorial optimization problem are associated with qubits. As represented by a number 1, in the QA process, the cost function H_{z}, the transverse magnetic field function Hₓ, and the orthogonal magnetic field function H_{y} are combined to serve as a total Hamiltonian H. In the number 1, t is defined as an elapsed time in the QA process, and varies in a numerical range between 0 and T. As shown in FIGS. 3 and 4, specifically in the present embodiment, t is defined as time until (i.e., up to) an annealing time T described later.

$$ℋ = A ( t ) {ℋ}_{z} + B ( t ) {ℋ}_{x} + {ℋ}_{y} \qquad [ Equation 1 ]$$

The cost function H_{z} is defined as a z-axis direction component of the total Hamiltonian H shown in FIG. 3. The cost function H_{z} represented by a number 2 is a function that is converged by optimization in the combinatorial optimization problem. In the number 2, σᵢ^{z} and σⱼ^{z} are Pauli matrices of the z-axis direction component for a pair of qubits with indices i and j, a combination of which is to be optimized. In the number 2, Jᵢⱼ is a coupling constant represented by a number 3 using a weight matrix wᵢⱼ of the combinatorial optimization problem. In particular, the coupling constant Jᵢⱼ of the present embodiment is defined as a random variable or the like that satisfies numbers 4, 5 such that the interaction based on SK (Sherrington-Kirkpatrick) Model is applied to the combinatorial optimization problem. Here, N in the number 5 is the number of qubits corresponding to the number of binary variables, and is the number of spins constituting the cost function H_{z}. In the combinatorial optimization problem using such cost function H_{z}, the combinations of N qubits having the 2^{N} combinations are optimized.

$${ℋ}_{z} = - {\sum }_{i < j} {J}_{ij} {σ}_{i}^{z} {σ}_{j}^{z} \qquad [ Equation 2 ]$$

$${J}_{ij} = - {w}_{ij} \qquad [ Equation 3 ]$$

$$p ( {J}_{ij} ) \sim \frac{1}{\sqrt{2 π {s}^{2}}} exp ( - \frac{{J}_{ij}^{2}}{2 {s}^{2}} ) \qquad [ Equation 4 ]$$

$${s}^{2} = \frac{1}{N - 1} \qquad [ Equation 5 ]$$

A coefficient function A(t) acting on the cost function H_{z} in the number 1 is represented by a number 6 as a time function as shown in FIG. 4 for an individual, time control of the cost function H_{z}. In the number 6, t is the elapsed time as in the number 1. In the number 6, T is the annealing time from the start to the end of the QA process, and is simplified as a value 1 in the present embodiment. In the number 6, a is a strength parameter for maximizing the coefficient function A(t), and is simplified as a value 1 in the present embodiment.

$$A ( t ) = at / T \qquad [ Equation 6 ]$$

The transverse magnetic field function Hₓ is a x-axis direction component of the total Hamiltonian H shown in FIG. 3. The transverse magnetic field function Hₓ is represented by a number 7 as a function for the quantum fluctuation representing a uniform magnetic field component in the x-axis direction orthogonal to the cost function H_{z} in the z-axis direction. In the number 7, σᵢ^{x} is a Pauli matrix of the x-axis direction component for a qubit with index i, a combination of which is to be optimized.

$${ℋ}_{x} = - {\sum }_{i} {σ}_{i}^{x} \qquad [ Equation 7 ]$$

A coefficient function B(t) acting on the horizontal magnetic field function Hₓ in the number 1 is represented by a number 8 as a time function as shown in FIG. 4 for an individual, time control of the horizontal magnetic field function Hₓ. In the number 8, t is the elapsed time as in the number 1. In the number 8, T is the annealing time as in the number 6. In the number 8, b is a strength parameter for maximizing the coefficient function B(t). In the present embodiment, an optimal parameter, e.g., 0.43, which is tested by experiments in advance is set for the strength parameter b.

$$B ( t ) = b ( 1 - t / T ) \qquad [ Equation 8 ]$$

The orthogonal magnetic field function H_{y} is a y-axis direction component of the total Hamiltonian H shown in FIG. 3. The orthogonal magnetic field function H_{y} is represented by a number 9 as a function representing a non-uniform magnetic field component in the y-axis direction orthogonal to both of (i) the cost function H_{z} in the z-axis direction and (ii) the transverse magnetic field function Hₓ in the x-axis direction. In the number 9, σᵢ^{y} is a Pauli matrix of the y-axis direction component for a qubit with index i, a combination of which is to be optimized.

$${ℋ}_{y} = - {\sum }_{i} {C}_{i} ( t ) {σ}_{i}^{y} \qquad [ Equation 9 ]$$

A coefficient function Cᵢ(t) constituting the orthogonal magnetic field function H_{y} in the number 9 is represented by a number 10 as a time function as shown in FIG. 4, for an individual, time control of the orthogonal magnetic field function H_{y} for a qubit with index i. In the number 10, t is the elapsed time as in the number 1. In the number 10, T is the annealing time as in the number 6. In the number 10, cᵢ is a strength parameter for giving the coefficient function cᵢ(t) a maximum value, in correspondence to a qubit with the index i. In the present embodiment, the cᵢ is set by the optimization block 120 as described later.

$${C}_{i} ( t ) = {c}_{i} {sin}^{2} ( π t / T ) \qquad [ Equation 10 ]$$

Through the QA process, a final state ψ__{f} of a wave function ψ shown in FIG. 3 for the total Hamiltonian H is obtained based on the time control of the total Hamiltonian by the quantum annealing. Under the time control of the total Hamiltonian H in the QA process, the final state ψ__{f} at time t=1 is obtained according to the Schrödinger number represented by a number 11.

$$\frac{d}{dt} \vert ψ 〉 = - i ℋ \vert ψ 〉 = - i ( A ( t ) {ℋ}_{z} + B ( t ) {ℋ}_{x} + {ℋ}_{y} ) \vert ψ 〉 \qquad [ Equation 11 ]$$

In the time control of the QA process as shown in FIGS. 3 and 4, the coefficient function A(t), which is a contribution of the cost function H_{z} to the total Hamiltonian H, is gradually increased from zero to a final value as time t elapses. Particularly, in the time control of the present embodiment, an output value of the coefficient function A(t) is increased, to a set value of the strength parameter a which is an end value, proportionally to the elapsed time t. Further, in the time control of the QA process, the coefficient function B(t), which is a contribution of the transverse magnetic field function Hₓ to the total Hamiltonian H, is decreased from an initial value to zero as time t elapses. Particularly, in the time control of the present embodiment, an output value of the coefficient function B(t) is decreased, from a set value of the strength parameter b which is an initial value, proportionally to the elapsed time t. Further, in the time control of the QA process, the coefficient function Cᵢ(t), which is a contribution of the orthogonal magnetic field function H_{y} to the total Hamiltonian H, is increased from zero to the maximum value as time t elapses, and then is decreased to zero as time t elapses. In particular, the time control of the present embodiment varies the output value of the coefficient function Cᵢ(t) proportionally to a square of a sine function, so that the coefficient function Cᵢ(t) in a wave form takes a maximum value which is a set value of the strength parameter cᵢ at a middle point between time 0 and an elapsed time t for a qubit with index i.

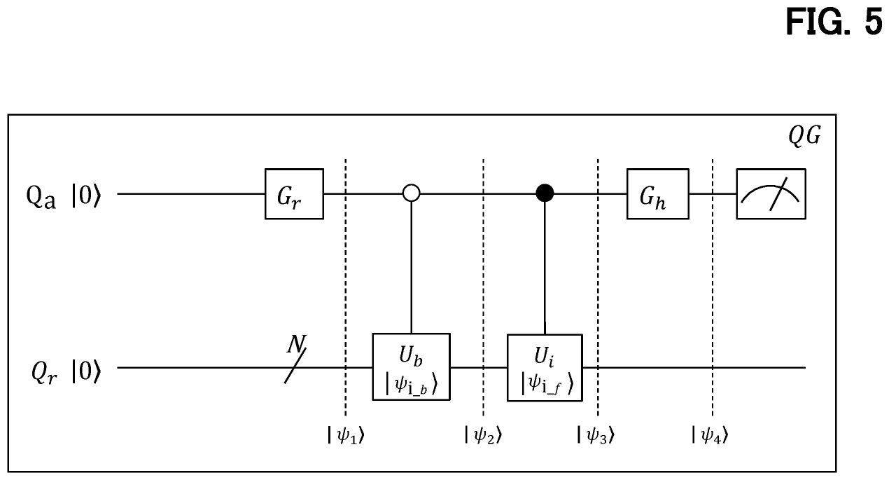

The gate block 110 shown in FIG. 2 is implemented (i) by the processors 12 in a gated quantum computer or (ii) as a combination of (a) the processors 12 in a gated quantum computer and (b) a set of the processors 12 and the memory 10 in a classical computer. The gate block 110 constructs a quantum gate circuit QG of a quantum gate system as shown in FIG. 5. Specifically, the quantum gate circuit QG receives a controlled qubit Qₐ for one qubit as an input. Here the controlled qubit Qₐ is an ancillary qubit whose input state is initialized to |0>. N pieces of register qubits Qᵣ are set with their input states respectively initialized to |0>.

The quantum gate circuit QG causes a rotation gate Gᵣ to act on the input controlled qubit Qₐ. The rotation gate Gᵣ is a control gate that transforms the controlled qubit Qₐ into a superposed state of a state |0> and a state |1> according to a number 12. A state |ψ₁> converted in such manner is represented by a number 13.

$${G}_{r} = \frac{1}{\sqrt{2}} ( \begin{matrix}1 & - i \\ - i & 1\end{matrix} ) \qquad [ Equation 12 ]$$

$$\vert {ψ}_{1} 〉 = ( \vert 0 〉 - i \vert 1 〉 ) \vert 0 〉 / \sqrt{2} \qquad [ Equation 13 ]$$

The quantum gate circuit QG causes a reference unitary gate U_{b} that kicks back a phase corresponding to a reference final state ψ_{b_f}, which is described later, among final states ψ__{f} of a wave function w for the total Hamiltonian H in the QA process, to act on the controlled qubit Qₐ. The reference unitary gate U_{b} performs the QA process on the register qubit Qᵣ of a branch in which the state of the controlled qubit Qₐ in the superposed state is |0>, and sets the state of the register qubit Qᵣ of the corresponding branch to the reference final state ψ_{b_f}. The state |ψ₂> thus subjected to phase kickback is represented by a number 14.

$$\vert {ψ}_{2} 〉 = ( \vert 0 〉 \vert {ψ}_{b \_ f} 〉 - i \vert 1 〉 \vert 0 〉 ) / \sqrt{2} \qquad [ Equation 14 ]$$

The quantum gate circuit QG causes an analysis unitary gate Uᵢ that kicks back a phase corresponding to an analysis final state ψ_{i_f}, which is described later, among the final states ψ__{f} of the wave function w for the full Hamiltonian H in the QA process, to act on the controlled qubit Qₐ. The analysis unitary gate Uᵢ performs the QA process on the register qubit Qᵣ of a branch in which the state of the controlled qubit Qₐ in the superposed state is |1>, and sets the state of the register qubit Qᵣ of the corresponding branch to the final state ψ_{i_f}. Thus, a state |ψ3> after further phase kickback is represented by a number 15.

$$\vert {ψ}_{3} 〉 = ( \vert 0 〉 \vert {ψ}_{b \_ f} 〉 - i \vert 1 〉 \vert {ψ}_{i \_ f} 〉 ) / \sqrt{2} \qquad [ Equation 15 ]$$

The quantum gate circuit QG causes an Hadamard gate Gₕ to act on the controlled qubit Qₐ to which the final states ψ_{b_f} and ψ_{i_f} are phase-kickbacked. The Hadamard gate Gₕ is a control gate that Hadamard-transforms the controlled qubit Qₐ by an Hadamard matrix of a number 16. A state |ψ4> thus subjected to the Hadamard transformation is represented by a number 17. As described above, in the quantum gate circuit QG, by the action of the two types of unitary gates U_{b} and Uᵢ, it is considered that the final states ψ_{b_f} and ψ_{i_f} before and after the variation of the strength parameter cᵢ, which is described later, are phase kickbacked for the controlled qubit Qₐ as shown in a number 17.

$${G}_{h} = \frac{1}{\sqrt{2}} ( \begin{matrix}1 & 1 \\ 1 & - 1\end{matrix} ) \qquad [ Equation 16 ]$$

$$\begin{matrix}\vert {ψ}_{4} 〉 = ( ( \vert 0 〉 + \vert 1 〉 ) \vert {ψ}_{b \_ f} 〉 - i ( \vert 0 〉 - \vert 1 〉 ) \vert {ψ}_{i \_ f} 〉 ) / 2 \\ = \vert 0 〉 ( \vert {ψ}_{b \_ f} 〉 - i \vert {ψ}_{i \_ f} 〉 ) / 2 + \vert 1 〉 ( \vert {ψ}_{b \_ f} 〉 + i \vert {ψ}_{i \_ f} 〉 ) / 2\end{matrix} \qquad [ Equation 17 ]$$

The quantum gate circuit QG outputs measurement data reflecting the phase information of the controlled qubit Qₐ. The measurement data output at this time are two types of probabilities P₀ and P₁. One probability P₀ is defined by a number 18 with respect to the state |0> of the controlled qubit Qₐ. The other probability P₁ is defined by a number 19 with respect to the state |1> of the controlled qubit Qₐ. Therefore, in the present embodiment, the probability values of the state |0> and the state |1> appearing by repeated (for example, 1000 or more) calculations using the quantum gate circuit QG are output as estimated measurement data of the probabilities P₀ and P₁, respectively.

$${{P}_{0} = \vert ( \vert {ψ}_{b \_ f} 〉 - i \vert {ψ}_{i \_ f} 〉 ) / 2 \vert}^{2} \qquad [ Equation 18 ]$$

$${{P}_{1} = \vert ( \vert {ψ}_{b \_ f} 〉 + i \vert {ψ}_{i \_ f} 〉 ) / 2 \vert}^{2} \qquad [ Equation 19 ]$$

The optimization block 120 shown in FIG. 2 is realized either (i) as a set of the processors 12 and the memory 10 in a classical computer, or (ii) a combination of (a) such a set and (b) at least one of the processor 12 in an annealing quantum computer and the processor 12 in a gate quantum computer. The optimization block 120 performs an optimization process to narrow down the solution space of the combinatorial optimization problem in order to solve the combinatorial optimization problem with binary variables. Specifically, the optimization block 120 is configured to perform the optimization process by sequentially determining an optimal value of the contribution of the orthogonal magnetic field function H_{y} for each of the binary qubits of the combinatorial optimization problem based on the final state ψ__{f} in the QA process. Hereinafter, the optimization process performed by the optimization block 120 is referred to as a QGO (Quantum Greedy Optimization) process.

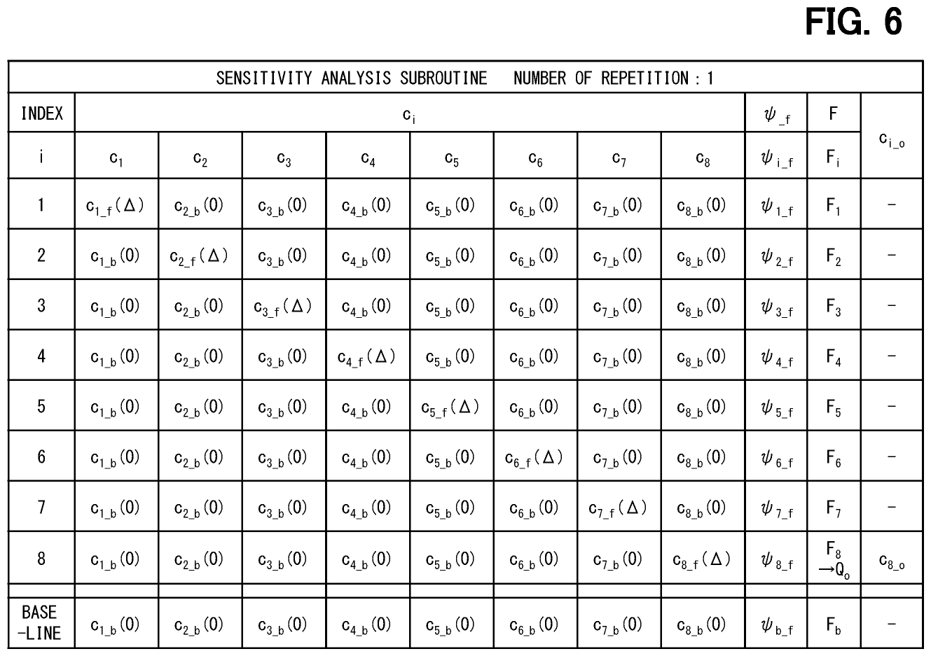

The QGO process initializes each of the strength parameters cᵢ, which cause the orthogonal magnetic field function H_{y} to have a maximum value, to a reference strength parameter c_{i_b} represented by a number 20, for N qubits optimizing 2^{N} combinations, i.e., for all qubits before optimization with indices i=an integer of 1 to N. At this time, each of the reference strength parameters c_{i_b} is set to a value of 0 as shown in FIG. 6 especially for any qubit with index i in the present embodiment. Note that FIG. 6 and FIGS. 7 to 9, which is described later, illustrate a case of N=8 (that is, i=an integer from 1 to 8).

$${c}_{i \_ b} = 0 \qquad [ Equation 20 ]$$

In the QGO process, a strength parameter c_{i_f} is set as a parameter different from the reference strength parameter c_{i_b}, as a corresponding strength parameter cᵢ with an index i for each of the qubits before optimization, which is made by applying a minute variation amount Δ to the reference strength parameter c_{i_b}. In the QGO process in which the reference strength parameter c_{i_b} is initialized to zero, the setting of the variation strength parameter c_{i_f} (=Δ) is performed according to a scheme shown in FIG. 6. Therefore, in the present embodiment, the minute variation amount Δ is set to an optimal amount such as 0.1, which is tested by experiment in advance.

$${c}_{i \_ f} = {c}_{i \_ b} + Δ = Δ \qquad [ Equation 21 ]$$

In the QGO process, a sensitivity analysis subroutine is repeatedly executed based on (i) the reference strength parameter c_{i_b} obtained by initializing the strength parameter cᵢ and (ii) the variation strength parameter c_{i_f} which is obtained by further changing the reference strength parameter c_{i_b} with a minute variation amount. Specifically, in the sensitivity analysis subroutine, the strength parameters c_{i_b} and c_{i_f} are passed from the optimization block 120 to the annealing block 100 for each of the qubits before optimization as shown in FIG. 2.

In the sensitivity analysis subroutine, the gate block 110 controls the annealing block 100 to which the strength parameters c_{i_b} and c_{i_f} are passed. According to the above-described control, the annealing block 100 performs the QA process by quantum annealing as shown in FIG. 6 for the register qubit Qᵣ. At this time, the reference unitary gate U_{b} and the analysis unitary gate Uᵢ act on the register qubit Qᵣ as the QA process under the control of the quantum gate circuit QG. Through such QA process, a superposed state is obtained in which (i) the reference final state ψ_{b_f} corresponding to the reference strength parameter c_{i_b} which is the strength parameter cᵢ before variation and (ii) the analysis final state ψ_{i_f} corresponding to the variation strength parameter c_{i_f} after variation of the strength parameter cᵢ are controlled according to the state of the controlled qubit Qₐ.

Here, in the QA process, the reference final state ψ_{b_f} prepared using the total Hamiltonian H having the reference strength parameter c_{i_b} of all indices i commonly used for all qubits before optimization as the reference strength parameter c_{i_b} is implemented by the reference unitary gate U_{b}. Together with the above, in the QA process, for each of the qubits before optimization, the analysis final state ψ_{i_f} corresponding to the parameter c_{i_f}, (i) prepared by using the total Hamiltonian H including the variation strength parameter c_{i_f} corresponding to the index i and the reference strength parameter c_{i_b} not corresponding to the index i, and (ii) corresponding to the variation strength parameter c_{i_f} is implemented by the analysis unitary gate Uᵢ.

The gate block 110, which has obtained the superposed state of the final states ψ_{b_f}, ψ_{i_f} before and after variation of the strength parameter cᵢ in the sensitivity analysis subroutine by controlling the annealing block 100, outputs, for each of the qubits before optimization, the probabilities P₀ and P₁ of the states |0> and |1> of the controlled qubit Qₐ from the quantum gate circuit QG. The probabilities P₀ and P₁ thus output are passed to the optimization block 120 as measurement data by the quantum gate circuit QG in the gate block 110 as shown in FIG. 2.

In the sensitivity analysis subroutine, the optimization block 120 performs an optimization operation to extracts, as an optimal qubit Qₒ, one qubit with the optimal evaluation index F from among all pre-optimization qubits corresponding to the passed measurement data having the probabilities P₀ and P₁. At this time, as the evaluation index F, an analysis evaluation index Fᵢ of the index i is assumed for an evaluation of the analysis final state ψ_{i_f} of the index i used for outputting the measurement data with the probabilities P₀ and P₁. Therefore, in particular, the analysis evaluation index Fᵢ is defined as a probability difference between the probabilities P₀ and P₁ according to a number 22.

$${F = {F}_{i} = {P}_{0} - {P}_{1} = \vert ( \vert {ψ}_{b \_ f} 〉 - i \vert {ψ}_{i \_ f} 〉 ) / 2 \vert}^{2} - \qquad [ Equation 22 ]$$

$${\vert ( \vert {ψ}_{b \_ f} 〉 + i \vert {ψ}_{i \_ f} 〉 ) / 2 \vert}^{2}$$

The number 22 is convertible into a number 23, according to transformation of numbers. According to the number 22, the analysis evaluation index Fᵢ represents an imaginary part Im <ψ_{b_f}|ψ_{i_f}> of an inner product regarding the final states ψ_{b_f} and ψ_{i_f} before and after the variation of the strength parameter cᵢ, from among the phase information kicked back by the quantum gate circuit QG, as the evaluation index F that is the phase information of the controlled qubit Qₐ.

$$\begin{matrix}F = {F}_{i} = \frac{1}{4} ( 〈 {ψ}_{b \_ f} \vert + i 〈 {ψ}_{i \_ f} \vert ) ( \vert {ψ}_{b \_ f} 〉 - i \vert {ψ}_{i \_ f} 〉 ) - \\ \frac{1}{4} ( 〈 {ψ}_{b \_ f} \vert - i 〈 {ψ}_{i \_ f} \vert ) ( \vert {ψ}_{b \_ f} 〉 + i \vert {ψ}_{i \_ f} 〉 ) \\ = \frac{1}{4} ( 2 - i 〈 {ψ}_{b \_ f} \vert {ψ}_{i \_ f} 〉 + i 〈 {ψ}_{i \_ f} \vert {ψ}_{b \_ f} 〉 ) - \\ \frac{1}{4} ( 2 + i 〈 {ψ}_{b \_ f} \vert {ψ}_{i \_ f} 〉 - i 〈 {ψ}_{i \_ f} \vert {ψ}_{b \_ f} 〉 ) \\ = Im 〈 {ψ}_{b \_ f} \vert {ψ}_{i \_ f} 〉\end{matrix} \qquad [ Equation 23 ]$$

Then, the optimization operation based on the evaluation index F in the sensitivity analysis subroutine extracts the optimal qubit Qₒ that maximizes an absolute value of the analysis evaluation index Fᵢ from among all the pre-optimization qubits according to a number 24 as shown in FIG. 6. Note that, in the number 24, the index i before the optimization operation is formally, or perfunctorily, represented using k and m so that the index of the optimal qubit Qₒ is treated as i after the optimization operation. Note also that FIG. 6 shows an example in which the optimal qubit Qₒ with index i=8 is extracted in the first cycle of the sensitivity analysis subroutine.

$$i ← {arg max}_{k ∈ \{ m \vert {c}_{m} = 0 \}} {F}_{k} \qquad [ Equation 24 ]$$

In the sensitivity analysis subroutine, the optimization block 120 determines, as the strength parameter cᵢ that has the optimal value of the extracted optimal qubit Qₒ, an optimal strength parameter c_{i_o} that satisfies a number 25 according to the analysis evaluation index Fᵢ corresponding to the optimal qubit Qₒ, as shown in FIG. 6. Here, c_{c} in the number 25 is set, as a constant parameter common to all of N pieces of qubits, to an optimal parameter such as π/2 (that is, 1.57) that has been pre-verified by demonstration experiments in the present embodiment in particular. Note that FIG. 6 shows an example in which the optimal qubit Qₒ with index i=8 is extracted and is determined as the optimal strength parameter c_{i_o} in the first cycle of the sensitivity analysis subroutine.

$${c}_{i \_ o} = - {c}_{c} sgn {F}_{i} \qquad [ Equation 25 ]$$

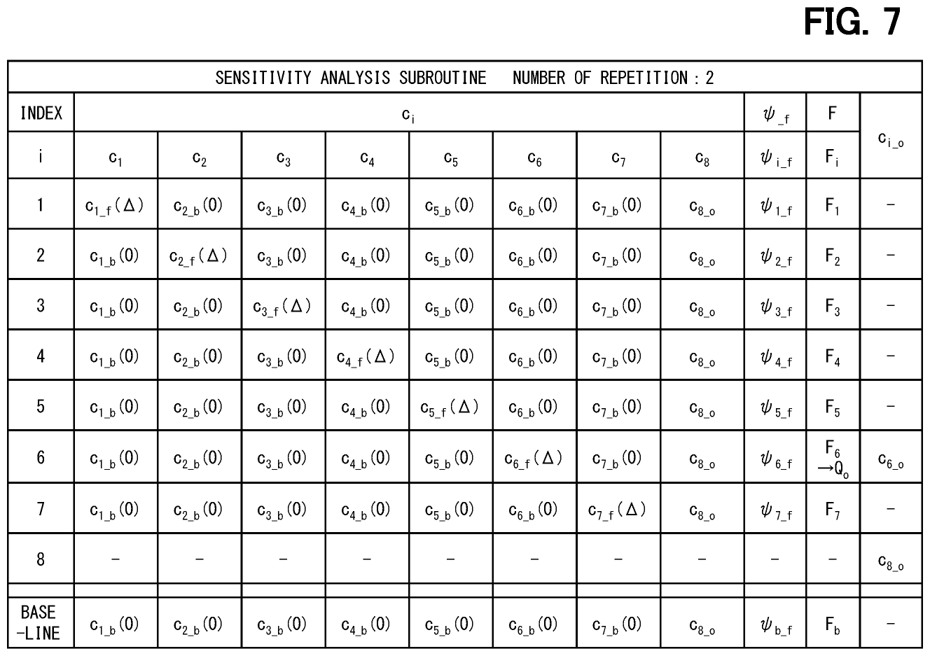

The optimization block 120 causes the sensitivity analysis subroutine to repeatedly change the strength parameters c_{i_b} and c_{i_f} passed from the optimization block 120 to the annealing block 100 and used for the QA process as shown in FIGS. 7 to 9, i.e., every time the optimal strength parameter c_{i_o} is determined. That is, in the second and subsequent cycles of the sensitivity analysis subroutine, for all optimal qubits Qₒ that have already been optimized in the preceding cycles of the sensitivity analysis subroutine, the corresponding optimal strength parameter c_{i_o} with index i is passed instead of the corresponding reference strength parameter c_{i_b} with index i.

As a result, in the second and subsequent cycles of the sensitivity analysis subroutine, when performing the QA process for obtaining the reference final state ψ_{b_f}, the reference strength parameter c_{i_b} whose index i corresponds to that of the optimal strength parameter cᵢ_o is replaced with such an optimal strength parameter c_{i_o}. Further, in the second and subsequent cycles of the sensitivity analysis subroutine, when performing the QA process for obtaining the analysis final state ψ^{i_f}, the reference strength parameter c_{i_b} (a) whose index i does not correspond to that of the optimal strength parameter c_{i_o} and (b) whose index i corresponds to that of the optimal strength parameter c_{i_o} is replaced with the optimal strength parameter c_{i_o} for each of the pre-optimization qubits other than the optimal qubit(s) Qₒ.

In such manner, in the second and subsequent cycles of the sensitivity analysis subroutine, an optimal qubit Qₒ is extracted, based on the evaluation index F, which is the phase information of the controlled qubit Qₐ whose phase is kicked back by the quantum gate circuit QG, from among the remaining pre-optimization qubits other than the optimal qubit Qₒ in the past cycle. Further, in the second and subsequent cycles of the sensitivity analysis subroutine, an optimal strength parameter c_{i_o} is determined regarding the extracted optimal qubit Qₒ, based on the evaluation index F, which is the phase information of the controlled qubit Qₐ whose phase is kicked back by the quantum gate circuit QG.

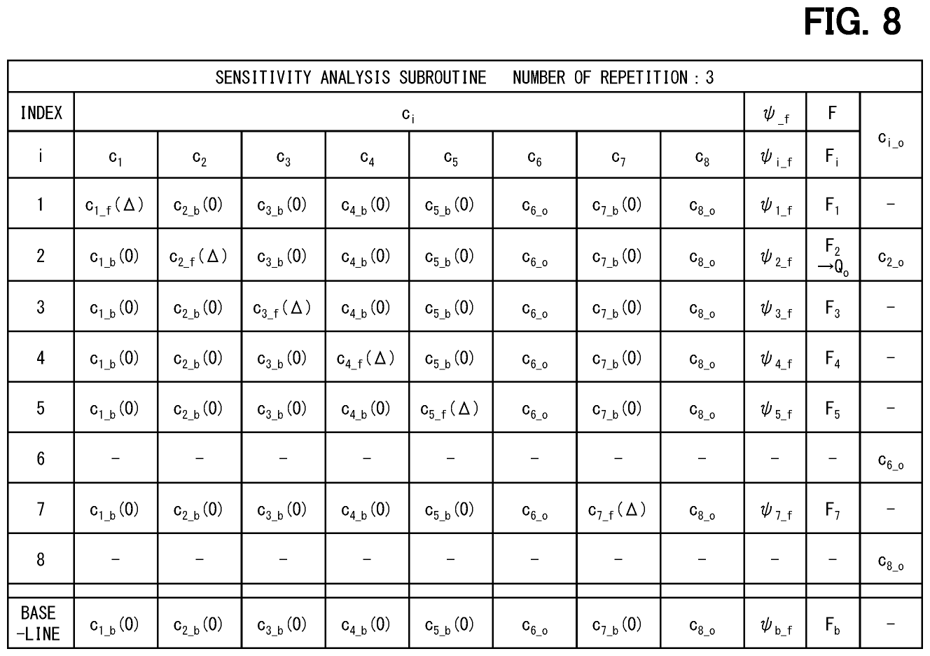

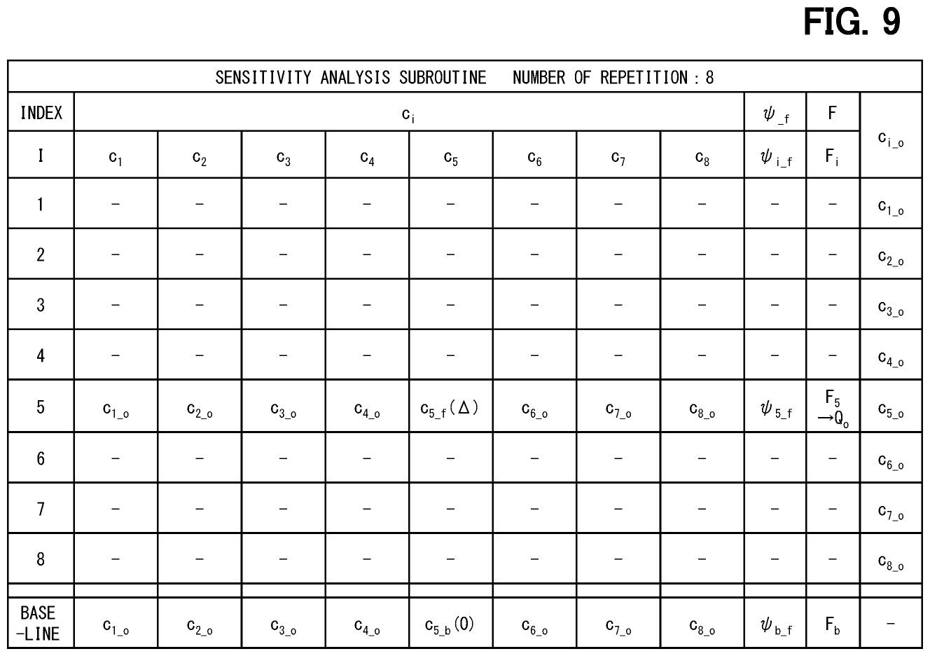

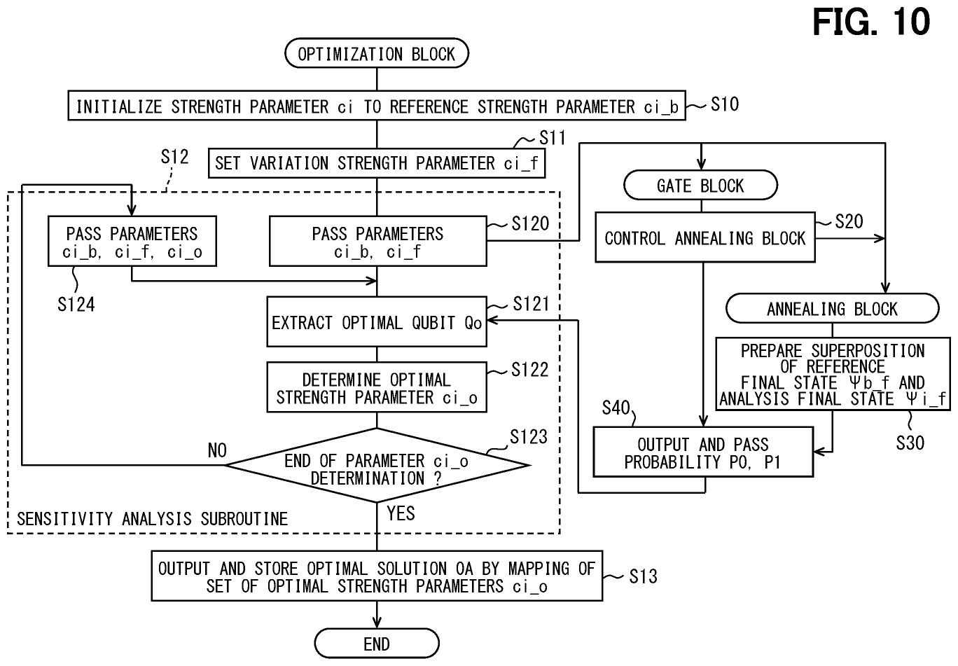

Note that, in FIG. 7, an example is shown, in which (i) an optimal strength parameter c_{i_o} is determined in the first cycle of the sensitivity analysis subroutine, by extracting an optimal qubit Qₒ with index i=8, and (ii) thereafter an optimal strength parameter c_{i_o} is determined by the QGO process in the second cycle of the sensitivity analysis subroutine, by extracting an optimal qubit Qₒ with index i=6. FIG. 8 shows an example, in which, after determination of the optimal strength parameters c_{i_o} by an extraction of the optimal qubits Qₒ with indices i=8 and 6 in the first and second cycles of the sensitivity analysis subroutine, an optimal strength parameter c_{i_o} is determined by the QGO process in the third cycle of the sensitivity analysis subroutine by extracting an optimal qubit Qₒ with index i=2. FIG. 9 shows an example, in which, after determination of the optimal strength parameters c_{i_o} by an extraction of the optimal qubits Qₒ with indices i=integer other than 5 in the first to seventh cycles of the sensitivity analysis subroutine, an optimal strength parameter c_{i_o} is determined by the QGO process in the eighth cycle of the sensitivity analysis subroutine by extracting an optimal qubit Qₒ with index i=5.

In the QGO process, the optimization block 120 determines an optimal strength parameter c_{i_o} for each of the N qubits, by repeating the sensitivity analysis subroutine by N cycles matching a number N of qubits. In such manner, the QGO process after determining the optimal strength parameters c_{i_o} for all the qubits outputs an optimal solution OA of the combinatorial optimization problem, by mapping a set of the optimal strength parameters c_{i_o} to the solution of the combinatorial optimization problem by a number 26. During such an output, the QGO process stores the output of the optimal solution OA in the memory 10. Here, storage of the output in the memory 10 may either be (a) holding output data even when the quantum computing system 1 is turned off, or (b) erasure of output data when the quantum computing system 1 is turned off.

$$OA = ( sgn {c}_{1 … o} , sgn {c}_{2 … o} , sgn {c}_{N … o} ) \qquad [ Equation 26 ]$$

With the cooperation of the blocks 100, 110 described above, the processing method in which the quantum computing system 1 controls the quantum annealing with binary qubits to solve the combinatorial optimization problem with binary variables is performed according to the sequence diagram shown in FIG. 10. The processing method shown in the sequence diagram is performed in response to an instruction from an operator of the quantum computing system 1, for example. Here, S in the sequence diagram means each of multiple steps executed by instructions included in each of the processing programs stored in multiple memories 10.

In S10 of the QGO process, the optimization block 120 initializes the strength parameter cᵢ for all pre-optimization qubits to the reference strength parameter c_{i_b}. In S11 of the QGO process, the optimization block 120 sets the variation strength parameter c_{i_f}, which is obtained by further changing the reference strength parameter c_{i_b}, for each of the pre-optimization qubits. In S12 of the QGO process, the optimization block 120 repeatedly executes the sensitivity analysis subroutine including S120 to S124.

Specifically, in S120 of the sensitivity analysis subroutine, the optimization block 120 passes the reference strength parameter c_{i_b} and the variation strength parameter c_{i_f} to the annealing block 100. The gate block 110 controls the annealing block 100 in S20, which is started in response to this passing of parameters. Further, in S30 according to the above-described control, the annealing block 100 uses the passed reference strength parameter c_{i_b} and the controlled qubit Qₐ of the gate block 110 to prepare a superposed state of the reference final state ψ_{b_f} and the analysis final state ψ_{i_f}. Then, in S40, the gate block 110 outputs, for each of the pre-optimization qubits by the quantum gate circuit QG, measurement data of the probabilities P₀ and P₁ regarding the states |0> and |1> of the controlled qubit Qₐ whose phase of the final states ψ_{b_f}, ψ_{i_f} is kicked back, and passes the output measurement data to the optimization block 120.

In S121 of the sensitivity analysis subroutine, the optimization block 120 uses the analysis evaluation index Fᵢ, which is the probability difference between the probabilities P₀ and P₁ passed from the gate block 110 in S40, as the evaluation index F, which is the phase information of the controlled qubit Qₐ, to perform the optimization operation. In such manner, the optimization block 120 extracts, in S121, the optimal qubit Qₒ having an optimal analysis evaluation index Fᵢ, which is an imaginary part Im <φ_{b_f}|φ_{i_f}> of an inner product of the final states ψ_{b_f}, φ_{i_f}, before and after the variation of the strength parameter cᵢ.

In S122 of the sensitivity analysis subroutine, the optimization block 120 determines the optimal strength parameter c_{i_o} for the optimal qubit Qₒ according to the analysis evaluation index Fᵢ, which is the evaluation index F corresponding to the optimal qubit Qₒ extracted in S121. In S123 of the sensitivity analysis subroutine, the optimization block 120 determines whether or not the determination of the optimal strength parameters c_{i_o} for all of N qubits has been complete.

When a negative determination is made in S123, S124 is performed instead of S120, so that the sensitivity analysis subroutine is repeated. In S124, the optimization block 120 passes the parameters c_{i_b}, c_{i_f}, c_{i_o} to the annealing block 100, by (i) replacing the determined optimal strength parameter c_{i_o} with the reference strength parameter c_{i_b} that has a corresponding index i, and with (ii) the other reference strength parameter c_{i_b} and the variation strength parameter c_{i_f} set according to S120. In response to such passing described above, steps S20, S30, S40, S121, S122, S123, and S124 are performed, in which qubits other than the optimal qubit Qₒ in the past cycle are treated as remaining qubits before optimization.

On the other hand, when an affirmative determination is made in S123, the sequence diagram proceeds to S13 by ending the sensitivity analysis subroutine. In S13 of the QGO process, the optimization block 120 outputs the optimal solution OA of the combinatorial optimization problem, by mapping the set of the optimal strength parameters c_{i_o} determined for all of N qubits. Further, in S125, the optimization block 120 stores the output optimal solution OA in the memory 10. In such manner, one cycle of the process shown in the sequence diagram ends.

### (Operational Effects)

In the QGO process of the present embodiment, the optimal values of the contribution of the orthogonal magnetic field function H_{y} are sequentially determined for each of qubits corresponding to binary variables based on the final state ψ^{_f} of the QA process that independently controls, in a time-dependent manner (i.e., that performs time control on), the contributions of the cost function H_{z}, the transverse magnetic field function Hₓ, and the orthogonal magnetic field function H_{y}. Then, the optimal qubit Qₒ is extracted, which optimizes the evaluation index F that gives the evaluation for the final state ψ__{f} of the QA process in which the strength parameter cᵢ is varied for having the maximum value of the orthogonal magnetic field function H_{y} regarding the pre-optimization qubit. At this time, the extraction of the optimal qubit Qₒ is performed based on the evaluation index F, which is the phase information of the controlled qubit Qₐ obtained by having the phase kickback of the final state ψ__{f} before and after the variation of the strength parameter cᵢ by the quantum gate circuit QG.

According to the above, even when the annealing time T in the QA process is shortened, by sequentially determining, according to the evaluation index F, the strength parameter cᵢ that is the optimal value of the extracted optimal qubit Qₒ, the solution space of the combinatorial optimization problem is narrowed down. Accordingly, highly-accurate optimal solution OA can be output by mapping the set of the strength parameters cᵢ determined for all qubits. Therefore, it is possible to achieve both of a reduction in the annealing time T and a highly-accurate output of the optimal solution OA, without compromise. Highly-accurate optimal solution OA, that is in other words, accuracy of solution is high, may mean either (a) probability of having the optimal solution OA is high, or (b) output of the solution with the cost function H_{z} having a low value after optimization.

### Other Embodiments

Although one embodiment has been described, the present disclosure should not be limited to the above embodiment, and may be applied to various other embodiments within the scope of the present disclosure.

In the optimization block 120 of a modification example, multiple optimal qubits Qₒ may be extracted in one cycle of the sensitivity analysis subroutine, in which case the optimal strength parameter c_{i_o} may be determined for each of the optimal qubits Qₒ. In the annealing block 100 of a modification example, by converting, via a time-controlled unitary conversion, (a) the y-direction components of the time-controlled Pauli matrix σᵢ^{y} represented by the number 9 into (b) the x-direction components of the time-controlled Pauli matrix σᵢ^{x} and the z-direction components of the Pauli matrix σᵢ^{z} for obtaining a new total Hamiltonian H, such a time control may be realized.

In addition to the above, the above-described embodiments and modification examples may also be implemented using a computer device or a semiconductor device (such as a semiconductor chip) having the processors 12 and the memory 10 for at least performing the QGO process of the quantum computing system 1.

1. A quantum computing system controlling quantum annealing and a quantum gate for processing a binary variable qubit to solve a combinatorial optimization problem of binary variables, the quantum computing system comprising:
a processor configured to execute:
an annealing process for individually time-controlling a contribution of each of:
(a) a cost function optimized in the combinatorial optimization problem;
(b) a transverse magnetic field function defining a magnetic field component orthogonal to the cost function; and
(c) an orthogonal magnetic field function defining a magnetic field component orthogonal to both the cost function and the transverse magnetic field function; and
an optimization process for sequentially determining, for each of the binary variable qubits that constitute an optimal solution of the combinatorial optimization problem, an optimal value of the contribution of the orthogonal magnetic field function based on a final state in the annealing process, and
an optimal qubit is defined as a qubit providing an optimal evaluation index in an evaluation of a final state of the annealing process in which a strength parameter of a pre-optimization qubit is varied for having a maximum value of the orthogonal magnetic field function, the optimization process includes:
(i) extracting of the optimal qubit based on the evaluation index, which is phase information of a controlled qubit whose final states before and after the variation of the strength parameter are phase kicked-back states by a quantum gate circuit;
(ii) determining of the strength parameter, which is the optimal value of the extracted optimal qubit, according to the evaluation index; and
(iii) outputting of the optimal solution by mapping a set of the strength parameters determined for all qubits.

2. The quantum computing system of claim 1, wherein
the optimization process further includes extracting of the optimal qubit based on the evaluation index which is an imaginary part of an inner product of the final states before and after the variation of the strength parameter, among the kicked-back phase information.

3. The quantum computing system of claim 2, wherein
the optimization process further includes determining of the strength parameter which is the optimal value of the optimal qubit, according to the evaluation index which is an imaginary part of an inner product of the final states before and after the variation of the strength parameter, among the kicked-back phase information.

4. The quantum computing system of claim 1, wherein
the optimization process further includes extracting of the optimal qubit, which optimizes the evaluation index when the strength parameter that has been initialized to zero for the pre-optimization qubit is varied.

5. The quantum computing system of claim 4, wherein
the strength parameter that has been initialized to zero is defined as a reference strength parameter,
the strength parameter that has been varied from the reference strength parameter is defined as a variation strength parameter, and
the optimization process further includes extracting of the optimal qubit based on the evaluation index which is the phase information having phase kickback of (a) a final state corresponding to the strength parameter before varied and (b) a final state corresponding to the strength parameter after varied.

6. The quantum computing system of claim 5, wherein
the optimization process further includes determining of the strength parameter that is an optimal value of the optimal qubit according to the evaluation index, which is the phase information obtained by having phase kickback of (a) a final state corresponding to the strength parameter before varied and (b) a final state corresponding to the strength parameter after varied.

7. The quantum computing system of claim 1, further comprising
a storage medium, wherein
the optimization process further includes storing of the optimal solution in the storage medium.

8. The quantum computing system of claim 1, wherein
the annealing process includes obtaining of a final state of a wave function corresponding to a total Hamiltonian of the cost function, the transverse magnetic field function and the orthogonal magnetic field function based on time control of the total Hamiltonian by the quantum annealing.

9. The quantum computing system of claim 8, wherein
the annealing process further includes:
increasing of the contribution of the cost function from zero to an end value as time elapses;
decreasing of the contribution of the transverse magnetic field function from a start value to zero as time elapses; and
decreasing of the contribution of the orthogonal magnetic field function to zero after increasing thereof from zero to the maximum value as time elapses.

10. A quantum computing device controlling quantum annealing and a quantum gate for processing a binary variable qubit to solve a combinatorial optimization problem of binary variables, the quantum computing device comprising:
a processor, wherein
(A) an annealing process is defined as a process for individually time-controlling a contribution of each of:
(a) a cost function optimized in the combinatorial optimization problem;
(b) a transverse magnetic field function defining a magnetic field component orthogonal to the cost function; and
(c) an orthogonal magnetic field function defining a magnetic field component orthogonal to the cost function and the transverse magnetic field function, and
(B) an optimization process is defined as a process for sequentially determining, for each of the binary variable qubits that constitute an optimal solution of the combinatorial optimization problem, an optimal value of the contribution of the orthogonal magnetic field function based on a final state in the annealing process, and
(C) an optimal qubit is defined as a qubit for providing an optimal evaluation index in an evaluation of a final state of the annealing process in which a strength parameter of a pre-optimization qubit is varied for having a maximum value of the orthogonal magnetic field function,
the processor is configured to perform the optimization process including:
(i) extracting of the optimal qubit based on the evaluation index, which is phase information of a controlled qubit whose final states before and after the variation of the strength parameter are phase kicked-back states by a quantum gate circuit;
(ii) determining of the strength parameter, which is the optimal value of the extracted optimal qubit, according to the evaluation index; and
(iii) outputting of the optimal solution by mapping a set of the strength parameters determined for all qubits.

11. A processing method performed by a processor, for controlling quantum annealing and a quantum gate for processing a binary variable qubit and for solving a combinatorial optimization problem of binary variables, the processing method comprising:
an annealing process for individually time-controlling a contribution of each of:
(a) a cost function optimized in the combinatorial optimization problem;
(b) a transverse magnetic field function defining a magnetic field component orthogonal to the cost function; and
(c) an orthogonal magnetic field function defining a magnetic field component orthogonal to the cost function and the transverse magnetic field function; and
an optimization process for sequentially determining, for each of the binary variable qubits that constitute an optimal solution of the combinatorial optimization problem, an optimal value of the contribution of the orthogonal magnetic field function based on a final state in the annealing process, and
an optimal qubit is defined as a qubit providing an optimal evaluation index in an evaluation of a final state of the annealing process in which a strength parameter of a pre-optimization qubit is varied for having a maximum value of the orthogonal magnetic field function, the optimization process includes:
(i) extracting of the optimal qubit based on the evaluation index, which is phase information of a controlled qubit whose final states before and after the variation of the strength parameter are phase kicked-back states by a quantum gate circuit;
(ii) determining of the strength parameter, which is the optimal value of the extracted optimal qubit, according to the evaluation index; and
(iii) outputting of the optimal solution by mapping a set of the strength parameters determined for all qubits.

12. A processing method performed by a processor, for controlling quantum annealing and a quantum gate for processing a binary variable qubit and for solving a combinatorial optimization problem of binary variables, the processing method comprising:
a process defined as an annealing process for individually time-controlling a contribution of each of:
(a) a cost function optimized in the combinatorial optimization problem;
(b) a transverse magnetic field function defining a magnetic field component orthogonal to the cost function; and
(c) an orthogonal magnetic field function defining a magnetic field component orthogonal to the cost function and the transverse magnetic field function; and
a process is defined as an optimization process for sequentially determining, for each of the binary variable qubits that constitute an optimal solution of the combinatorial optimization problem, an optimal value of the contribution of the orthogonal magnetic field function based on a final state in the annealing process, and
an optimal qubit is defined as a qubit providing an optimal evaluation index in an evaluation of a final state of the annealing process in which a strength parameter of a pre-optimization qubit is varied for having a maximum value of the orthogonal magnetic field function, the optimization process includes:
(i) extracting of the optimal qubit based on the evaluation index, which is phase information of a controlled qubit whose final states before and after the variation of the strength parameter are phase kicked-back states by a quantum gate circuit;
(ii) determining of the strength parameter, which is the optimal value of the extracted optimal qubit, according to the evaluation index; and
(iii) outputting of the optimal solution by mapping a set of the strength parameters determined for all qubits.

13. A non-transitory, computer readable, tangible storage medium storing a processing program including instructions stored in a storage medium and executed by a processor, for controlling quantum annealing and a quantum gate for processing a binary variable qubit and for solving a combinatorial optimization problem of binary variables, processes provided by the processing program comprising:
an annealing process performed according to the instructions for individually time-controlling a contribution of each of:
(a) a cost function optimized in the combinatorial optimization problem;
(b) a transverse magnetic field function defining a magnetic field component orthogonal to the cost function; and
(c) an orthogonal magnetic field function defining a magnetic field component orthogonal to the cost function and the transverse magnetic field function; and
an optimization process performed according to the instructions for sequentially determining, for each of the binary variable qubits that constitute an optimal solution of the combinatorial optimization problem, an optimal value of the contribution of the orthogonal magnetic field function based on a final state in the annealing process, wherein
an optimal qubit is defined as a qubit providing an optimal evaluation index in an evaluation of a final state of the annealing process in which a strength parameter of a pre-optimization qubit is varied for having a maximum value of the orthogonal magnetic field function, the optimization process includes:
(i) extracting of the optimal qubit based on the evaluation index, which is phase information of a controlled qubit whose final states before and after the variation of the strength parameter are phase kicked-back states by a quantum gate circuit;
(ii) determining of the strength parameter, which is the optimal value of the extracted optimal qubit, according to the evaluation index; and
(iii) outputting of the optimal solution by mapping a set of the strength parameters determined for all qubits.

14. A non-transitory, computer readable, tangible storage medium storing a processing program including instructions stored in a storage medium and executed by a processor, for controlling quantum annealing and a quantum gate for processing a binary variable qubit and for solving a combinatorial optimization problem of binary variables, processes provided by the processing program comprising:
a process designated as an annealing process for individually time-controlling a contribution of each of:
(a) a cost function optimized in the combinatorial optimization problem;
(b) a transverse magnetic field function defining a magnetic field component orthogonal to the cost function; and
(c) an orthogonal magnetic field function defining a magnetic field component orthogonal to the cost function and the transverse magnetic field function; and
a process designated as an optimization process for sequentially determining, for each of the binary variable qubits that constitute an optimal solution of the combinatorial optimization problem, an optimal value of the contribution of the orthogonal magnetic field function based on a final state in the annealing process, and
an optimal qubit is defined as a qubit providing an optimal evaluation index in an evaluation of a final state of the annealing process in which a strength parameter of a pre-optimization qubit is varied for having a maximum value of the orthogonal magnetic field function, the optimization process includes:
(i) extracting of the optimal qubit based on the evaluation index, which is phase information of a controlled qubit whose final states before and after the variation of the strength parameter are phase kicked-back states by a quantum gate circuit;
(ii) determining of the strength parameter, which is the optimal value of the extracted optimal qubit, according to the evaluation index; and
(iii) outputting of the optimal solution by mapping a set of the strength parameters determined for all qubits.
